(19) United States
(12) Patent Application Publication
(10) Pub. No.: US 2019/0159971 A1
(43) Pub. Date: May 30, 2019

(54) DEVICE AND METHOD FOR THE METERED FILLING OF A CONTAINER WITH A FILLING MATERIAL

(71) Applicant: Harro Hoefliger Verpackungsmaschinen GmbH, Allmersbach im Tal (DE)

(72) Inventors: Elke STERNBERGER-RUETZEL, Allmersbach im Tal (DE); Philipp GAUS, Allmersbach im Tal (DE); Sabine WILDENHAIN, Allmersbach im Tal (DE); Michael ROEHRLE, Allmersbach im Tal (DE); Jonas HOFMEISTER, Allmersbach im Tal (DE); Daniel MUELLER, Allmersbach im Tal (DE)

(73) Assignee: Harro Hoefliger Verpackungsmaschinen GmbH, Allmersbach im Tal (DE)

(21) Appl. No.: 16/203,926

(22) Filed: Nov. 29, 2018

(30) Foreign Application Priority Data
Nov. 30, 2017 (EP) 17 001 962.4

(51) Int. Cl. A61J 3/07; B65B 1/36

(52) U.S. Cl. CPC A61J 3/074; B65B 37/20; B65B 1/36

(57) ABSTRACT

A device for the metered filling of a container with a filling material includes a receiving unit for receiving a container and at least one material store as a storage container for the filling material. A defined quantity of the filling material is able to be removed from the at least one material store and transferred into the container by a filling unit. The filling unit includes at least one metering chamber which is displaceably mounted so that the metering chamber is present alternately in a first position and in a second position. In its first position the metering chamber is in contact with the material store so that filling material is able to be filled into the metering chamber from the material store. In its second position the metering chamber is arranged above the container so that the filling material located in the metering chamber is able to be emptied into the container. The container may, in particular, be a drinking straw.

### CROSS REFERENCE TO RELATED APPLICATIONS

Applicant claims priority under 35 U.S.C. § 119 of European Application No. 17 001 962.4 filed Nov. 30, 2017, the disclosure of which is incorporated by reference.

### BACKGROUND OF THE INVENTION

### 1. Field of the Invention

The invention relates to a device and a method for the metered filling of a container with a pourable or flowable filling material. Such devices are used, in particular, when producing nutritional supplements or medicaments. In these cases, a filling material containing an active substance is filled into a suitable container so that the filling material and thus also the active substance may be swallowed, for example, as a capsule.

### 2. Description of the Related Art

Depending on the type of metering, two main groups of preparations of active substances are known. Firstly, the active substance may already be correctly pre-metered, for example in the form of tablets, filled hard gelatine capsules or injection ampoules. In this case, each unit of the preparation already contains the correct, predetermined dose of the active substance. Secondly, preparations exist in non-metered form from a reservoir (container), for example in the form of ointments, powders, granules or pellets. In this case, the respectively required quantity of product and thus also of active substance is taken individually. If the respective active substance has a large therapeutic window, the patient and/or consumer may take such an individual dose directly. If the active substance, however, has only a very narrow therapeutic window—i.e. the boundary between a dose which is as yet ineffective and a dose which already causes undesirable side effects is very small—the patient should no longer take the active substance individually in an uncontrolled manner.

Preparations comprising pre-metered active substances are produced, in particular, on an industrial scale when the respective dosage is to be provided in a large quantity. This is the case, for example, for antibiotics. Other treatments, however, require a dosage which is individual to the patient and which, for example, relates to the respective body weight. In this case, industrial production is generally cost-intensive and thus economically inefficient. Thus individual metering is generally performed in the pharmacy or hospital pharmacy. For example, a series of oncology drugs and psychotherapeutic drugs has to be metered individually. Specifically in geriatrics and paediatrics relatively conventional medicaments such as antibiotics frequently also have to be metered individually. This is required in order to take account of the differences in body weight and in physical condition and in some cases also in order to take account of the specific metabolism in small children.

When metering an active substance to be individually dispensed to a patient, this is generally weighed out in the hospital pharmacy, for example. Alternatively, a specific volume of the active substance which corresponds to the required dose of the active substance may also be measured out. In order to simplify the intake for the patient, the individual dose is frequently filled into hard gelatine capsules. Such capsules which are assembled from a capsule lower part and a capsule upper part are a common means of administering powdery or pellet-shaped active substances. They may be produced and filled on an industrial scale in very large quantities but may also be used in pharmacies for producing separate individual doses.

Nowadays, drinking straws are also used for administering active substances and/or food supplements. Such a drinking straw is disclosed, for example, in EP 1 843 683 B1. The active substance is present, in particular, in this case in the form of granules, pellets, microtablets or powders, and preferably has a size in the range of approximately 250 micrometres up to 4 millimetres. The average size in this case is approximately 250 micrometres up to 710 micrometres. The active substance in this case is already located in the drinking straw and preferably is suctioned with a liquid from the drinking straw into the mouth of the patient and subsequently swallowed. This makes it easier for the patient to take the active substance since generally the active substance may be swallowed much more easily. This may be advantageous, in particular, in patients with swallowing difficulties (for example in paediatrics and/or geriatrics). By taking the active substance as an in situ suspension with the liquid, the taste of the active substance, for example, may be masked by the liquid. The patient may adapt the taste as desired by different beverages. With the use of pellets these are generally functionally coated. In this manner, a masking of the taste may also be possible. Moreover, a specific release profile may also be obtained. The drinking straws are generally produced on an industrial scale and, therefore, contain an accurately predetermined dose of a medicament.

### SUMMARY OF THE INVENTION

Proceeding from this already disclosed prior art, the object of the invention is to provide an improved device for the metered filling of a container with a filling material containing an active substance, which in particular permits individual filling of the containers in pharmacies and/or hospital pharmacies. In this case, in particular, smaller quantities of containers are designed to be able to be filled cost-effectively, rapidly and reliably.

The device for the metered filling of a container with a filling material is provided by the features according to one aspect of the invention. The method for the metered filling of a container with a filling material is provided by the features according to another aspect of the invention. Expedient developments of the invention form the subject-matter of further embodiments discussed below.

The device according to the invention for the metered filling of a container with a filling material comprises a receiving unit for receiving the container and at least one material store as a storage container for the filling material to be filled. A defined quantity of the filling material is able to be removed from the at least one material store and transferred into the container by means of a filling unit. According to the invention, the filling unit comprises at least one metering chamber which is displaceably mounted. As a result, the at least one metering chamber may be present alternately in a first position and in a second position. In its first position, the metering chamber is in contact with the material store so that filling material is able to be filled into the metering chamber from the material store. In its second position, the metering chamber is arranged above the container to be filled, so that the filling material located in the metering chamber is able to be emptied into the container.

By the use of just two possible positions for the metering chambers, the device may be of very compact construction. The device is thus suitable, in particular, for filling relatively few containers with a specific dose of active substance. The device according to the invention in this case, in particular, may be used in pharmacies or hospitals, in order to fill into a suitable container the quantity of active substance individually required for a patient.

The metering chamber may be displaceable, in particular, in the forward direction and in the opposing direction thereto. Such a movement to and fro may generally be carried out using just one hand and provisional positioning and handling is generally not required at the same time. This simplifies the operation of the device according to the invention for the person carrying out the filling procedure.

In a first embodiment, the device may have merely the above-described one metering chamber. In this case, it would be necessary to perform the forward movement and rearward movement in order to complete a filling procedure. Preferably, in this case the metering chamber may be mounted so as to be longitudinally displaceable. Such a mounting is able to be implemented in a structurally simple manner and at the same time permits a simple and convenient operation.

In a second embodiment, the device may comprise a first metering chamber and a second metering chamber. The two metering chambers in each case may be present alternately in a first position and in a second position. Whilst one of the two metering chambers is in its first position and is filled with the filling material to be filled, the second of the two metering chambers is in its second position and empties the filling material located in the metering chamber into the container. In their second position, both metering chambers have to be present in an identical position above the container in order to permit an exact and reproducible filling of the container. The first position of the two metering chambers, however, may be different, as long as both metering chambers are able to be filled in their respective first position with the same quantity of the same filling material.

In an embodiment which is particularly simple structurally, the two metering chambers are displaceable in each case from their first position into their second position by a rotational movement. If the rotational movement in this case respectively encloses an angle of 180 degrees, the two metering chambers may be exactly exchanged in their positions by the rotational movement. In this case, the two metering chambers would be present in their second position at identical positions below the material store.

In an advantageous embodiment, two material stores may be present. In this case, the first metering chamber could be present in its first position below the first material store and in its second position above the container. However, the second metering chamber could be present in its first position below the second material store and in its second position above the container. In this manner, the first metering chamber could meter a first filling material (with a first active substance) into the container, whilst the second metering chamber could meter a second filling material which is different therefrom (with a second active substance) into the container. The two different filling materials could have identical or even different concentrations of the active substance.

In order to prevent when emptying the metering chamber that a portion of the filling material falls to the side of the container, a funnel element may be arranged between the at least one metering chamber and the upper edge of the container.

In a particularly preferred embodiment, the container may be configured as a drinking straw. The drinking straw should in this case be already sealed at its lower end by suitable means so that the filling material may not fall down out of the drinking straw. After removing the drinking straw from the device, this drinking straw may be closed by means of a separate cap. By means of the device according to the invention, therefore, for the first time it is possible to fill small quantities of drinking straws individually. This permits new applications of drinking straws in administering active substances to patients.

Preferably, the device according to the invention may have a weighing unit. The weight of the filling material which has been filled in may be accurately determined by the weighing unit. The weighing unit could in this case measure the weight of the filling material still located in the material store and/or the weight of the filling material already located in the container.

Alternatively or additionally thereto, a counting unit could be present. By means of the counting unit, the number of changes in position of the at least one metering chamber may be counted and displayed. Generally, a container is filled with several doses of filling material. The active substance, therefore, is generally present in a relatively small concentration in the filling material, so that different doses of active substance may be achieved by filling a defined number of metering chamber fillings with filling material. At the same time, the counting unit may prevent errors during the filling procedure, which may occur for example by the operator being distracted.

In a particularly preferred embodiment, a printer unit may be present. An automatic record-keeping of the filling procedure is possible by means of the printer unit. This may be carried out retrospectively or at the same time as the filling procedure.

In the method according to the invention for the metered filling of a container with a filling material, initially a metering chamber is positioned below a material store for the filling material. Thus a defined portion of the filling material may be filled into this metering chamber. Subsequently, the metering chamber is displaced slightly out of this first position below the material store into a second position. In its second position, the metering chamber is located above the container to be filled so that the filling material may fall out of the metering chamber into the container. Subsequently, the metering chamber is displaced again into its first position so that the metering chamber may be refilled with filling material.

Preferably, in each case a plurality of portions of filling material are filled into the same container. As a result, the filling material present in the material store may be used for filling different required doses of active substance. This may be implemented in a particularly simple embodiment by the metering chamber being repeatedly transferred successively from its first position into its second position and back again into the first position.

In a preferred embodiment, a first metering chamber and a second metering chamber may be present, in each case said metering chambers being present alternately in their first position and in their second position. As a result, the two metering chambers may exchange places when transferred into the respective other position. With each transfer of the metering chambers into the respective other position, therefore, a portion of the filling material may be filled into the container. At the same time, the filling of the next container may be already begun immediately after changing the container, without first having to fill the active substance into the metering chamber.

The device according to the invention and the method according to the invention are not limited to any specific type of filling material. In principle, any material may be regarded as filling material provided it may be divided into units which all have substantially the same quantity of active substance. This is the case, in particular, of such solid materials which are present in the form of granules, pellets or microtablets. In principle, liquids may also be correspondingly metered, in particular when these liquids are present in the form of microcapsules. The invention is of significance, in particular, in the case of filling materials with high-value active substances, so as not to drive up costs unnecessarily for a treatment. An individual filling of the respectively required doses may also be advantageous in the case of active substances with a short storage life.

Further advantages and features of the invention are to be derived from the features also set forth in the claims and the following exemplary embodiments.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a schematic longitudinal section through a first embodiment of the device according to the invention, in which the individual metering chambers are in their first position below the material store;

FIG. 2 shows a schematic longitudinal section through the device according to FIG. 1, in which the individual metering chamber is located in its second position above the container;

FIG. 3 shows a schematic longitudinal section through a second embodiment of the device according to the invention, in which the first metering chamber is located in its first position below the material store and the second metering chamber is located in its second position above the container;

FIG. 4 shows a perspective view of the device according to FIG. 3 without the material store; and

FIG. 5 shows a schematic longitudinal section through a third embodiment of the device according to the invention, in which the first metering chamber is located in its first position below a first material store and the second metering chamber is located in its second position above the container.

### DETAILED DESCRIPTION OF PREFERRED EMBODIMENTS

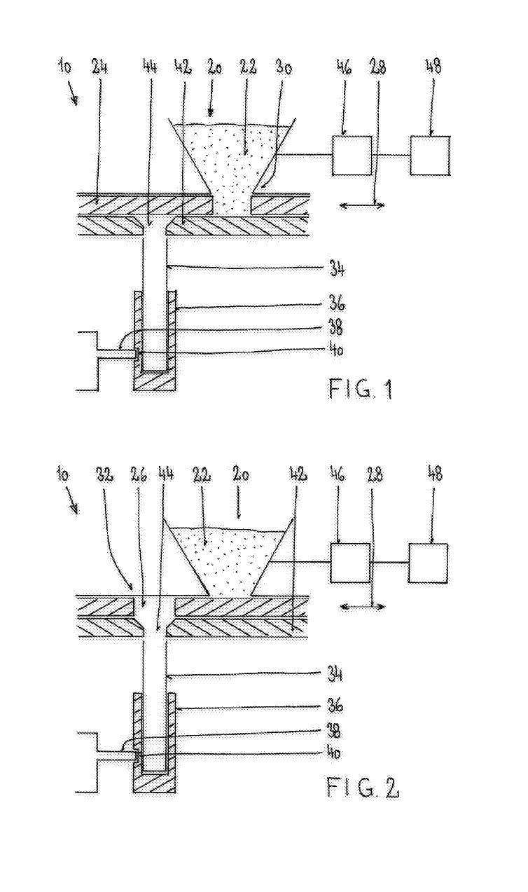

A first embodiment of the device 10 according to the invention is shown schematically in FIGS. 1 and 2. The device 10 has a material store 20 in which a filling material 22 is held in storage. The filling material 22 in the present exemplary embodiment is in the form of pellets which in each case contain a defined quantity of an active substance. Thus a uniform distribution may be achieved of the concentration of the active substance in the filling material 22. A metering disc 24 is located below the material store 20. In the present exemplary embodiment, an individual metering chamber 26 is formed in the metering disc 24. The metering chamber 26 is able to receive a specific quantity of filling material 22. The metering disc 24 in the present exemplary embodiment may be displaced to and fro in the longitudinal direction 28. As a result, the metering chamber 26 may be transferred from its first position 30 shown in FIG. 1 below the material store 20 into a second position 32 shown in FIG. 2. From this second position 32, the metering chamber 26 may be displaced back again into its first position 30.

In its second position 32 the metering chamber 26 is located above the opening of a container 34. The container 34 in the present exemplary embodiment is configured as a drinking straw. The drinking straw 34 is mounted upright in a receiving unit 36, so that the opening of the drinking straw 34 faces upwardly. In order to remove the drinking straw 34 after filling and to be able to replace it for a new empty drinking straw, the receiving unit 36 may be removed from the device 10. After removing the receiving unit 36, the drinking straw 34 may be removed. Subsequently, the receiving unit 36 may be positioned again in the device 10 with a new drinking straw 34. In order ensure that the receiving unit 36 and thus also the drinking straw 34 to be filled are in the correct position, the device 10 in the present exemplary embodiment has a latching element 38. The latching element 38 in the correct position of the receiving unit 36 extends into a recess 40 of the receiving unit 36 and may be latched there by suitable counter-means. Only when this contact is made is the metering disc 24 able to move. As a result, incorrect filling may be prevented. At the same time, with an inadvertent actuation of the metering disc 24 without the receiving unit 36 being inserted (for example when transporting the device 10) it is impossible that valuable filling material 22 is able to be removed from the material store 20.

In order to facilitate the filling of the filling material 22, a stationary plate 42 is present below the metering disc 24. A funnel element in the form of a funnel-shaped opening 44 is formed in this plate 42. This funnel-shaped opening 44 is positioned directly above the edge region of the drinking straw 34.

In the present example, the removal of the filling material 22 from the material store 20 is monitored by means of a weighing unit 46. In the present example, the weighing unit 46 determines the weight of the filling material 22 present in the material store 20. Alternatively or additionally, the weight of the filling material already present in the container 34 could also be determined by means of a weighing unit. The weighing unit 46 is connected to a printer unit 48 corresponding to FIGS. 1 and 2. As a result, the measurement result may be emitted via the printer unit 48 and thus recorded. In contrast to the exemplary embodiment shown here, the weighing unit 46 and/or the printer unit 48 could also be dispensed with.

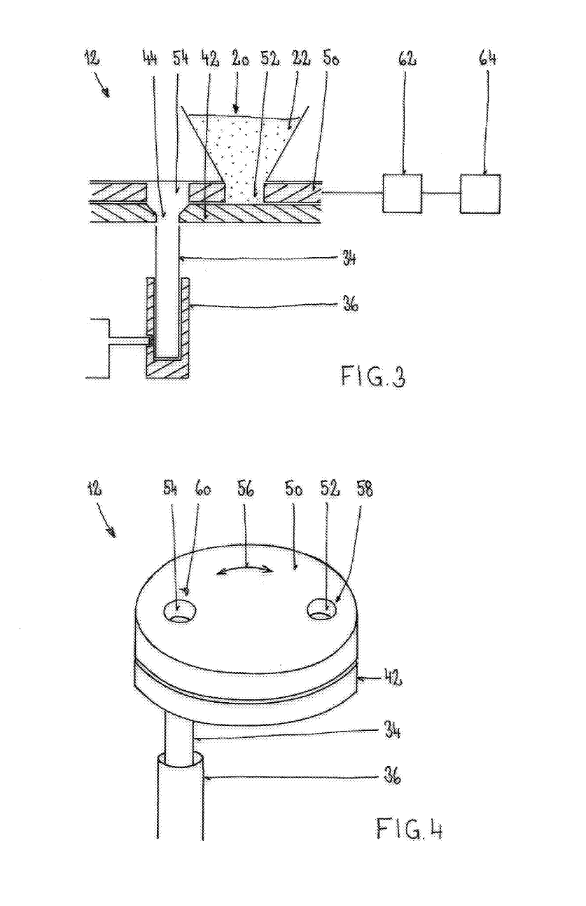

A second embodiment of the device 12 according to the invention is shown schematically in FIGS. 3 and 4. The device 12 has a material store 20 in which a filling material 22 is held in storage. A metering disc 50 is located below the material store 20. In the present exemplary embodiment, two metering chambers 52, 54 are formed in the metering disc 50. The two metering chambers 52, 54 in each case may receive a specific quantity of filling material 22, wherein both metering chambers 52, 54 in each case may receive exactly the same quantity of filling material 22. The metering disc 50 in the present example may be rotated to and fro in the direction of the arrow 56. Whilst in FIGS. 3 and 4 the first metering chamber 52 is in its first position 58 below the material store 20, the second metering chamber 54 in FIGS. 3 and 4 is in its second position 60 above the container 34. After rotating the metering disc 50, the first metering chamber 52 would be located in its second position above the drinking straw 34 and the second metering chamber 54 in its first position below the material store 20. As in the case of the device 10 according to FIGS. 1 and 2, the device 12 according to FIGS. 3 and 4 also has a stationary plate 42 with a funnel-shaped opening 44 below the metering disc 50.

In the present example, the removal of the filling material 22 from the material store 20 is monitored by means of a counting unit 62 (see FIG. 3). In the present example, the counting unit 62 determines the number of changes in position of the two metering chambers 52, 54. The counting unit 62 is connected to a printer unit 64 corresponding to FIG. 3. The result may be output, therefore, via the printer unit 64 and thus recorded. In contrast to the exemplary embodiment shown here, the counter unit 62, 46 and/or the printer unit 64 could also be dispensed with.

Alternatively or additionally, according to FIGS. 3 and 4 the device 12 could also be provided with a weighing unit 46 comparable with FIGS. 1 and 2. The device 10 according to FIGS. 1 and 2 could also be provided with a counting unit 62 comparable with FIG. 3.

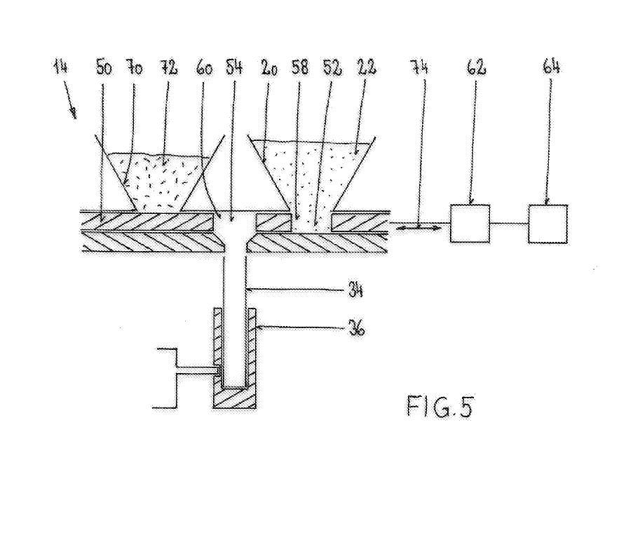

A third embodiment of the device according to the invention 14 is shown schematically in FIG. 5. The device 14 has a first material store 20 in which a first filling material 22 is held in storage. Moreover, the device 14 has a second material store 70 in which a second filling material 72 is held in storage. A metering disc 50 with two metering chambers 52, 54 is located below the two material stores 20, 70. In the present example, the metering disc 50 may be displaced to and fro in the longitudinal direction 74. Whilst the first metering chamber 52 in FIG. 5 in its first position 58 is below the first material store 20, the second metering chamber 54 in FIG. 5 in its second position 60 is above the container 34. After displacing the metering disc 50, the first metering chamber 52 would be located in its second position above the drinking straw 34 and the second metering chamber 54 in its first position below the second material store 70. By means of the first metering chamber 52, therefore, a first filling material 22 may be filled into the container 34. However, the second metering chamber 54 may fill the container 34 with a second filling material 72.

Comparable with the devices 10 and/or 12 the device 14 could also be provided with a weighing unit 46 and/or a counting unit 62, in each case with or without a printer unit 48, 64.

Generally, more than one filling of the metering chamber 26, 52, 54 is required in order to fill the desired quantity of filling material 22, 72 and thus also the desired dose of active substance into the drinking straw 34. The metering disc 24, 50 is, therefore, generally repeatedly moved to and fro before the drinking straw 34 is removed. If the concentration of active substance in the filling material 22, 72 is known, in this manner different quantities of active substance may be filled accurately.

If other quantities of filling material are to be filled, a replacement of the metering disc 24, 50 and thus an adaptation of the size of the metering chambers 26, 52, 54 may also be possible. Optionally, the adaptation of the size of the metering chambers 26, 52, 54 could also be implemented by different inserts in the metering disc 24, 50.

Although only a few embodiments of the present invention have been shown and described, it is to be understood that many changes and modifications may be made thereunto without departing from the spirit and scope of the invention.

What is claimed is:

1. A device (10, 12, 14) for the metered filling of a container (34) with a filling material (22, 72), the device comprising:
a receiving unit (36) for receiving a container (34);
at least one material store (20, 70) as a storage container for the filling material (22, 72); and
a filling unit, a defined quantity of the filling material (22, 72) being able to be removed from the at least one material store (20,70) and transferred into the container (34) by means of said filling unit;
wherein
the filling unit comprises at least one metering chamber (26, 52, 54);
the at least one metering chamber (26, 52, 54) is displaceably mounted so that the metering chamber (26, 52, 54) is present alternately in a first position (30, 58) and in a second position (32, 60);
in the first position (30, 58) the metering chamber (26, 52, 54) is in contact with the material store (20, 70) so that filling material (22, 72) is able to be filled into the metering chamber (26, 52, 54) from the material store (20, 70); and
in the second position (32, 60) the metering chamber (26, 52, 54) is arranged above the container (34) so that the filling material (22, 72) located in the metering chamber (26, 52, 54) is able to be emptied into the container (34).

2. The device according to claim 1, wherein the metering chamber (26, 52, 54) is displaceable in the forward direction and in the opposing direction thereto.

3. The device according to claim 2, wherein the metering chamber (26, 52, 54) is mounted so as to be longitudinally displaceable.

4. The device according to claim 1, wherein
a first metering chamber (52) and a second metering chamber (54) are present;
the two metering chambers (52, 54) are present alternately in a first position (58) and in a second position (60); and
the two metering chambers (52, 54) are present in their second position (60) in an identical position above the container (34).

5. The device according to claim 4, wherein the two metering chambers (52, 54) are displaceable in each case from their first position (58) into their second position (60) by a rotational movement (56).

6. The device according to claim 4, wherein
a first material store (20) and a second material store (70) are present;
the first metering chamber (52) is present in its first position (58) below the first material store (20) and in its second position (60) above the container (34); and
the second metering chamber (54) is present in its first position (58) below the second material store (70) and in its second position (60) above the container (34).

7. The device according to claim 1, wherein a funnel element (44) is arranged between the at least one metering chamber (26, 52, 54) and the upper edge of the container (34).

8. The device according to claim 1, wherein the container is configured as a drinking straw (34).

9. The device according to claim 1, wherein a weighing unit (46) is present.

10. The device according to claim 1, wherein
a counting unit (62) is present; and
the counting unit (62) displays the number of changes in position of the at least one metering chamber (26, 52, 54).

11. The device according to claim 1, wherein a printer unit (48, 64) is present.

12. A method for the metered filling of a container (34) with a filling material (22, 72), comprising the following method steps:
a metering chamber (26,52, 54) is positioned in its first position (30, 58) below a material store (20, 70);
the filling material (22, 72) is transferred from the material store (20, 70) into the metering chamber (26, 52, 54);
the metering chamber (26, 52, 54) is displaced slightly out of its first position (30, 58) so that the metering chamber (26, 52, 54) is positioned in a second position (32, 60) above the container (34);
the filling material (22, 72) falls out of the metering chamber (26, 52, 54) into the container (34); and
the metering chamber (26, 52, 54) is displaced again from the second position (32, 60) into the first position (30, 58) so that the metering chamber (26, 52, 54) may be refilled with filling material (22, 72).

13. The method according to claim 12, wherein a plurality of portions of filling material (22, 72) are filled into the container (34).

14. The method according to claim 13, wherein for filling a container (34) the metering chamber (26, 52, 54) is repeatedly transferred from the first position (30, 58) into the second position (32, 60) and back again into the first position (30, 58).

15. The method according to claim 1, wherein a first metering chamber (52) and a second metering chamber (54) are present; and
in each case the two metering chamber (52, 54) are present alternately in their first position (58) and in their second position (60).
